(19) United States
(12) Patent Application Publication
(10) Pub. No.: US 2025/0370462 A1
(43) Pub. Date: Dec. 4, 2025

(54) ROBOT BASED ON ORIGAMI PRINCIPLES AND CONTROL METHOD THEREOF, CONTROLLER, AND STORAGE MEDIUM

(71) Applicant: SOUTHERN UNIVERSITY OF SCIENCE AND TECHNOLOGY, Shenzhen (CN)

(72) Inventors: HUIJUAN FENG, Shenzhen (CN); JIANG LIN, Shenzhen (CN); WEIHAO WANG, Shenzhen (CN); LIZI DENG, Shenzhen (CN); ZHONGQI MIAO, Shenzhen (CN); HAOLIN ZHANG, Shenzhen (CN); JIANSHENG DAI, Shenzhen (CN)

(73) Assignee: SOUTHERN UNIVERSITY OF SCIENCE AND TECHNOLOGY, Shenzhen (CN)

(21) Appl. No.: 19/174,166

(22) Filed: Apr. 9, 2025

(30) Foreign Application Priority Data
Jun. 3, 2024 (CN) 202410708194.4

(51) Int. Cl. G05D 1/60; G05D 1/221; G05D 109/50

(52) U.S. Cl. CPC G05D 1/60; G05D 1/221; G05D 2109/50

(57) ABSTRACT

A robot based on origami principles, includes: linkage components, central panels, and a plurality of sector-shaped panels, wherein: two ends of the linkage components are connected to a same number of the sector-shaped panels, with every two adjacent sector-shaped panels connected by a respective one of connecting elements; the central panels are located in a middle of the linkage components, and the central panels are configured for placement of a control assembly, the control assembly comprising a folding/unfolding motor and a motion control system; the folding/unfolding motor is configured to drive the connecting elements to control the robot to switch to any one of a multirotor configuration, a wheel configuration, or a waterborne motion configuration.

### CROSS-REFERENCE TO RELATED APPLICATION

This application is based on and claims the benefit of foreign priority from Chinese Patent Application No. 202410708194.4, filed on Jun. 3, 2024, the entirety of which is incorporated by reference herein.

### TECHNICAL FIELD

The present disclosure relates to the field of origami robot technology, and in particular to a robot based on origami principles and a control method thereof, a controller, and a storage medium.

### BACKGROUND

With the rapid development of science and technology, robot technology has been applied to various life scenarios, bringing great convenience to people's lives. At present, widely used types include wheeled robots and rotorcraft robots. Wheeled robots can adapt well to flat terrains, offering stable motion and high-speed movement capabilities. Rotorcraft robots can operate in aerial flight conditions, providing functions such as aerial surveying. Aquatic robots can perform well in offshore exploration, water quality detection, etc.

Therefore, to enable robots to adapt to more application scenarios and fully leverage the advantages of all three types, it is essential to integrate wheeled robots, rotorcraft robots, and aquatic robots, achieving seamless switching between the three robotic motion modes and multifunctionality. In the related art, a simple combination of the motion functionalities of wheeled and rotorcraft robots is achieved by adding passive wheels to a rotorcraft robot. However, this approach not only increases the size of the robot but also affects flight stability, failing to fully utilize the advantages of existing wheeled and rotorcraft robots. Alternatively, another method introduces multiple degrees of freedom to increase the motion modes of the robot, which, however, increases the complexity of the control algorithms. Neither method allows for complete switching between a wheel configuration and a rotorcraft configuration, nor does it enable gliding on water or diving movements. Furthermore, it is impossible to achieve independent motion modes in respective configurations.

### SUMMARY

A main objective of embodiments of the present disclosure is to provide a robot based on origami principles and a control method thereof, a controller, and a storage medium.

In order to achieve the above objective, an embodiment in a first aspect of the present disclosure provides a robot based on origami principles, comprising:
linkage components, central panels, and a plurality of sector-shaped panels, wherein:
two ends of the linkage components are connected to a same number of the sector-shaped panels, with every two adjacent sector-shaped panels connected by a respective one of connecting elements;
the central panels are located in a middle of the linkage components, and the central panels are configured for placement of a control assembly, the control assembly comprising a folding/unfolding motor and a motion control system;
the folding/unfolding motor is configured to drive the connecting elements to control the robot to switch to any one of a multirotor configuration, a wheel configuration, or a waterborne motion configuration, wherein the multirotor configuration refers to a state in which the sector-shaped panels at each end overlap in pairs, the wheel configuration refers to a state in which the sector-shaped panels at each end unfold in pairs, and the waterborne motion configuration refers to a state in which the sector-shaped panels at each end unfold in pairs within a preset angle range; and
the motion control system is configured to control the robot to enter any one of a flight mode in the multirotor configuration, a rolling mode in the wheel configuration, or a waterborne motion mode in the waterborne motion configuration.

The robot according to the embodiment in the first aspect of the present disclosure has at least the following beneficial effects. The robot designed based on a origami structure with single degree of freedom can achieve complete switching between a multirotor configuration, a wheel configuration and a waterborne motion configuration of the robot through folding and unfolding movements with single degree of freedom, and can enter a flight mode in the multirotor configuration of the robot, enter a rolling mode in the wheel configuration of the robot, and enter a waterborne motion mode in the waterborne motion configuration of the robot, with the three motion modes operating independently of each other.

In some embodiments, each of the sector-shaped panels is provided with a through-hole, a rotor component is mounted in the through-hole of at least one of the sector-shaped panels at each end, the rotor component comprises a rotor motor and blades, and the rotor motor is configured to drive the blades to rotate in any one of the flight mode, the rolling mode, or the waterborne motion mode.

In some embodiments, the rotor component is mounted in the through-hole of one of every two adjacent sector-shaped panels.

In some embodiments, a side of the sector-shaped panel that is away from the central panels is mounted with an arc-shaped support component, the arc-shaped support component comprising a buoyancy assembly.

In some embodiments, a slot is provided in a mirrored configuration for each connecting element in the two adjacent sector-shaped panels, and the slot is configured to, when in the state of overlapping in pairs, accommodate the respective connecting element that is in the mirrored configuration.

In order to achieve the above objective, an embodiment in a second aspect of the present disclosure provides a motion control method of a robot, including:
driving the connecting elements by the folding/unfolding motor to control the robot to switch to any one of a multirotor configuration, a wheel configuration, or a waterborne motion configuration, where the multirotor configuration refers to a state in which the sector-shaped panels at each end overlap in pairs, the wheel configuration refers to a state in which the sector-shaped panels at each end unfold in pairs, and the waterborne motion configuration refers to a state in which the sector-shaped panels at each end unfold in pairs within a preset angle range;
in the multirotor configuration, controlling, by the motion control system, the robot to enter a flight mode in the multirotor configuration;
in the wheel configuration, controlling, by the motion control system, the robot to enter a rolling mode in the wheel configuration; and
in the waterborne motion configuration, controlling, by the motion control system, the robot to enter a waterborne motion mode in the waterborne motion configuration.

The motion control method of the robot according to the embodiment of the second aspect of the present disclosure has at least the following beneficial effects. A dynamic model is established to enable the robot to switch between the multirotor configuration, the wheel configuration and the waterborne motion configuration through folding and unfolding movements; the folding/unfolding motor drives the robot to fold and unfold to realize the complete switching between the multirotor configuration, the wheel configuration and the waterborne motion configuration; and the motion control system controls the robot for flight, rolling, gliding motion on the water surface or diving motion.

In some embodiments, the controlling, by the motion control system, the robot to enter a flight mode in the multirotor configuration comprises:
acquiring remote controller control information and ground station control information, and acquiring state monitoring information of the robot;
calculating flight motion information of the robot based on the remote controller control information, the ground station control information, and the state monitoring information; and
transmitting the flight motion information to a mixer for outputting a control signal for the rotor motor, such that the rotor motor drives the robot to fly based on the flight motion information.

In some embodiments, the controlling, by the motion control system, the robot to enter a rolling mode in the wheel configuration comprises:
acquiring remote controller control information and ground station control information, and acquiring state monitoring information of the robot;
calculating rolling information of the robot based on the remote controller control information, the ground station control information, and the state monitoring information; and
transmitting the rolling information to a mixer for outputting a control signal for the rotor motor, such that the rotor motor drives the robot to roll based on the rolling information.

In some embodiments, the controlling, by the motion control system, the robot to enter a waterborne motion mode in the waterborne motion configuration comprises:
acquiring remote controller control information and ground station control information, and acquiring state monitoring information of the robot;
calculating waterborne motion information of the robot based on the remote controller control information, the ground station control information, and the state monitoring information; and
transmitting the waterborne motion information to a mixer for outputting a control signal for the rotor motor, such that the rotor motor drives the robot to perform waterborne motion based on the waterborne motion information.

In order to achieve the above objective, an embodiment in a third aspect of the present disclosure provides a controller, including a memory and a processor, where the memory stores a computer program which, when executed by the processor, causes the processor to implement the motion control method in the second aspect described above.

In order to achieve the above objective, an embodiment in a fourth aspect of the present disclosure provides a computer-readable storage medium storing a computer program which, when executed by a processor, causes the processor to implement the motion control method in the second aspect described above.

Additional features and advantages of the present disclosure will be set forth in the subsequent description, and in part will become apparent from the description, or may be learned by practice of the present disclosure. The objectives and other advantages of the present disclosure can be realized and obtained by structures specified in the description, the claims and the accompanying drawings.

### BRIEF DESCRIPTION OF DRAWINGS

FIG. 1 is a schematic diagram of an origami unit according to an embodiment of the present disclosure;

FIG. 2 is a schematic diagram of an origami link frame according to an embodiment of the present disclosure;

FIG. 3 is a schematic diagram of an origami slab according to an embodiment of the present disclosure;

FIG. 4 is a schematic diagram of an overall structure of a robot according to an embodiment of the present disclosure;

FIG. 5 is a schematic diagram of a multirotor configuration of a robot according to an embodiment of the present disclosure;

FIG. 6 is a flowchart of a motion control method according to an embodiment of the present disclosure;

FIG. 7 is a schematic diagram of a robot motion control system according to an embodiment of the present disclosure;

FIG. 8 is a structural diagram of a flight control module according to an embodiment of the present disclosure;

FIG. 9 is a structural diagram of a rolling control module according to an embodiment of the present disclosure;

FIG. 10 is a structural diagram of a waterborne motion control module according to an embodiment of the present disclosure;

FIG. 11 is a flowchart of step 602 in FIG. 6 according to an embodiment of the present disclosure;

FIG. 12 is a flowchart of step 603 in FIG. 6 according to an embodiment of the present disclosure;

FIG. 13 is a flowchart of step 604 in FIG. 6 according to an embodiment of the present disclosure; and

FIG. 14 is a schematic diagram of a controller for executing a motion control method of a robot according to an embodiment of the present disclosure.

### LIST OF REFERENCE NUMERALS

Robot 100, linkage component 110, central panel 111, connecting rod 112, sector-shaped panel 130, slot 131, arc-shaped support component 132, buoyancy assembly 1321, connecting element 140, rotor component 150, rotor motor 151, blade 152, through-hole 160, folding/unfolding motor 170, power supply 180, and rotating shaft 190.

### DETAILED DESCRIPTION

In order to make the objectives, technical schemes and advantages of the present disclosure more apparent, the present disclosure is further described in detail in conjunction with the accompanying drawings and embodiments. It should be understood that the particular embodiments described herein are only intended to explain the present disclosure, and are not intended to limit the present disclosure.

It is to be noted that although a functional module division is shown in a schematic diagram of an apparatus and a logical order is shown in a flowchart, in some cases, the apparatus may be divided differently, or the steps shown or described may be executed in a different order from that in the flowchart. The terms such as “first” and “second” in the description, claims and above-mentioned drawings are intended to distinguish between similar objects and are not necessarily to describe a specific order or sequence.

Unless otherwise defined, all the technical and scientific terms used herein have the same meanings as those commonly understood by those of ordinary skills in the art to which the present disclosure pertains. The terminology used herein is for the purpose of describing embodiments of the present disclosure only and is not intended to limit the present disclosure.

Traditional wheeled robots possess the ability for stable movement and high-speed mobility, demonstrating good adaptability on flat terrain. They can be used in scenarios such as industrial facility inspections, construction site patrols, and providing meal services in restaurants. However, wheeled robots struggle with precise and effective obstacle avoidance and navigation when encountering complex terrain or obstacles, such as irregular surfaces or narrow spaces, limiting their application in certain specific scenarios.

Unmanned Aerial Vehicles (UAVs) have the capability to fly freely in the air, offering high flexibility and enabling applications in aerial surveying, agricultural irrigation, and more. However, the flight planning of UAVs in narrow spaces is restricted, presenting limitations in certain application scenarios.

Aquatic robots can perform well in marine environment monitoring, water quality detection, underwater terrain surveying, and other functions, which are crucial for the development of maritime endeavors.

Therefore, it is essential to combine these three types of robots to fully leverage their functionalities and adapt to more application scenarios.

Currently, some research has explored adding passive wheels and rotor structures to multiple rotors of a robot, so as to control the robot to roll on the ground by relying on the thrust of the rotors. However, there are many problems with this simple structural combination. For example, during rotor flight, as passive wheels increase the size of the robot, the flight stability is affected, and obstacle avoidance also becomes difficult. Meanwhile, the control algorithms for the robot become more complex, hindering the ability to fully utilize the advantages of both wheeled and rotorcraft robots. In addition, related technologies have also attempted to increase the motion modes of the flying robots by increasing the degrees of freedom of the robot body and the degrees of freedom of rotor steering. However, introducing too many degrees of freedom complicates the control algorithms and may impact the stability of the control process, while also failing to enable the water surface gliding or diving motion of the robot.

In view of this, embodiments of the present disclosure provide a robot based on origami principles and a control method thereof, a controller, and a storage medium.

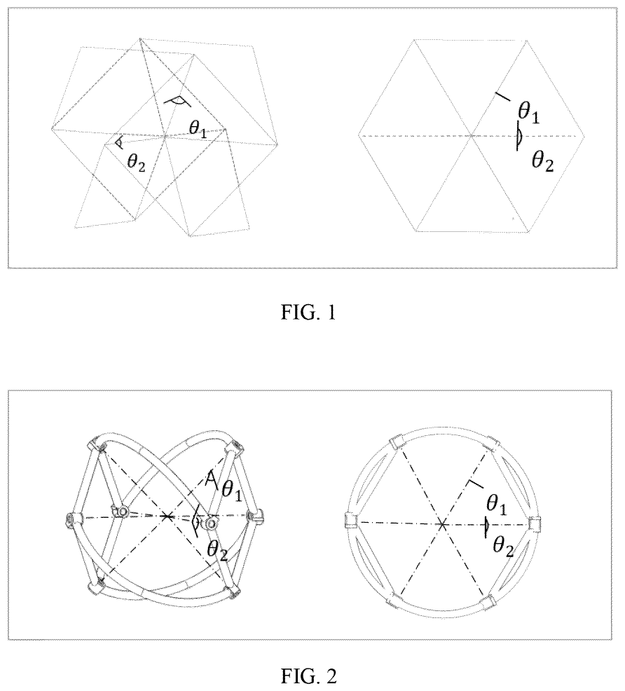

First, the design principle of the robot according to the embodiments of the present disclosure will be described. As shown in FIG. 1, FIG. 1 is a schematic diagram of an origami unit according to an embodiment of the present disclosure. FIG. 1 shows the main creases and angular relationships of chiral origami, which is a single degree of freedom structure. When θ₁=θ₂, the origami structure is in an unfolded state, and a basic link frame of the robot in the wheel configuration can be designed according to the crease on its outer contour. When θ₁=0 and θ₂=π, the origami structure is in a folded state, and a basic link frame of the robot in the multirotor configuration can be designed according to the crease on the outer contour of the origami. The chiral origami unit can be abstracted as two coupled spherical four-bar linkages. The spherical four-bar linkage includes four rotational pairs, with each crease connection abstracted as a rotational pair. In total, there are four creases, corresponding to four rotational pairs, with the axes of each rotational pair intersecting at the same spherical center.

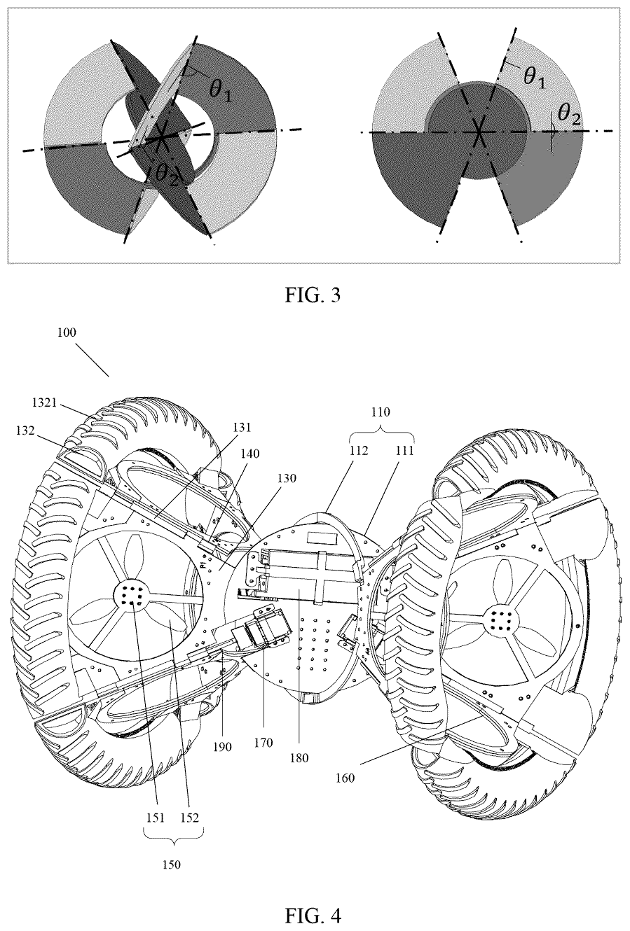

Further, as shown in FIG. 2, FIG. 2 is a schematic diagram of an origami link frame according to an embodiment of the present disclosure. An origami link frame based on the origami unit is designed through the origami unit, and the origami link frame is two coupled spherical four-bar linkages. Accordingly, it is possible to satisfy the requirement of the chiral origami unit as a wheel or a rotor. When the origami link frame is fully unfolded, the robot can realize the wheel configuration, and when the origami link frame is fully folded, the robot can realize the multirotor configuration. Still further, after determining the basic link frame, the present disclosure confirms a slab model based on the origami structure described above. As shown in FIG. 3, FIG. 3 is a schematic diagram of an origami slab according to an embodiment of the present disclosure. The origami slab structure includes a central panel 111 and sector-shaped panels 130, and the entity of the robot is constructed by the origami slab structure.

Referring to FIG. 4, based on the above description of the chiral origami unit, the present disclosure has designed a robot 100 based on origami principles, and the structure of the robot 100 according to embodiments of the present disclosure will be described below. In some embodiments, the overall structure of the robot 100 includes linkage components 110, central panels 111, and a plurality of sector-shaped panels 130. Two ends of the linkage components 110 are connected to the same number of the sector-shaped panels 130, with every two adjacent sector-shaped panels 130 connected by a connecting element 140. The central panels 111 are located in the middle of the linkage components 110, and the central panels 111 are configured for placement of a control assembly, the control assembly comprising a folding/unfolding motor 170 and a motion control system. The folding/unfolding motor 170 is used to drive the connecting elements 140 to control the robot 100 to switch to a multirotor configuration, a wheel configuration, or a waterborne motion configuration. For the robot 100, the multirotor configuration refers to a state in which the sector-shaped panels 130 at each end overlap in pairs, the wheel configuration refers to a state in which the sector-shaped panels at each end unfold in pairs, and the waterborne motion configuration refers to a corresponding motion configuration in which an included angle formed by the adjacent sector-shaped panels 130 at each end is within a preset angle range. The waterborne motion configuration may be the same as the wheel configuration, that is, the robot 100 can move in the water in the wheel configuration. The waterborne motion configuration can also be obtained by appropriate angular transformation from the wheel configuration or multirotor configuration. When the robot 100 is in the waterborne motion configuration, the included angle between the adjacent sector-shaped panels 130 at each end is a preset angle, where the preset angle may range from 45 degrees to 135 degrees. It can be understood that when the angle between the adjacent sector-shaped panels 130 at each end is within a preset angle range, the robot 100 can form a suitable angle with the water surface, which can reduce the resistance of the robot 100 moving in the water, and the motion control system can provide sufficient thrust for the robot 100 to support the movement of the robot 100 in the water. The motion control system is configured for controlling the robot 100 to enter a flight mode in the rotor mode, controlling the robot 100 to enter a rolling mode in the wheel configuration, or controlling the robot 100 to enter a waterborne motion mode in the waterborne motion configuration. Specifically, the waterborne motion mode may include gliding on the water surface or diving. The robot 100 may roll to the water surface from the land, and then the robot 100 may maintain the wheel configuration while partially floating on the water surface, or the robot 100 may start on the water surface or land from the air onto the water surface, partially floating on the water surface, and gliding on the water surface without rolling.

It can be understood that the central panel 111 may be a circular slab and can rotate about the center of the robot 100, thereby ensuring that the robot 100 remains relatively stable during folding, unfolding, and moving. The number of the central panels 111 is an even number. The central panels 111 may be used to connect the sector-shaped panels 130 at opposite positions at two ends of the robot 100, or devices such as a power supply 180, a sensor (not shown), a motor (not shown), and an electronic speed controller (not shown) may be placed on the central panels 111. The plurality of central panels 111 overlap each other and are provided in the middle of the linkage components 110, and the materials of the sector-shaped panels 130 and the central panels 111 can be selected according to actual situations, with no restrictions specified here.

Further, both ends of the robot 100 include an equal number of sector-shaped panels 130, and the number of sector-shaped panels 130 at each end is an even number, for example, six, eight, or the like, so as to ensure that the sector-shaped panels 130 at both ends of the robot 100 can overlap in pairs when the robot 100 is in the multirotor configuration. The linkage components 110 may include a plurality of connecting rods 112, and the connecting rods 112 may be rotatably adjusted according to the folding and unfolding of the sector-shaped panels 130, and the central panel 111 is also a part of the linkage component 110. The number of linkage components 110 may be set according to the number of sector-shaped panels 130 at both ends, and the linkage components 110 are used to connect the sector-shaped panels 130 at opposite positions, and every two linkage components 110 overlap each other relatively. Every two adjacent sector-shaped panels 130 are connected by the connecting element 140 at their shared boundary. The connecting element 140 is provided at the radius sides of two adjacent sector-shaped panels 130, and the connecting element 140 may be a hinge or a pivot. The connecting elements 140 are connected to a folding/unfolding motor 170 by rotating shafts (not shown), and the folding/unfolding motor 170 controls the opening and closing of the connecting elements 140 by the rotating shafts to control the folding and unfolding of the sector-shaped panels 130 by the opening and closing of the connecting elements 140.

It is to be understood that the folding/unfolding motor 170 may be a motor of various brands without any limitation herein. The folding/unfolding motor 170 may drive the robot 100 into any of a multirotor configuration, a wheel configuration, or a waterborne motion configuration by driving the connecting elements 140 (which may be hinges or pivots), or may drive other parts of the robot 100 by other driving manners to realize the configuration switching of the robot 100 in a single degree of freedom. The folding/unfolding motor 170 may serve as a steering gear when the robot 100 performs waterborne motion. When the robot 100 rolls from the land to the water surface, the robot 100 maintains the steering gear attitude angle corresponding to the rolling state, and rolls while partially floating on the water surface. When the robot 100 is started on the water surface, or when the robot 100 descends from the air onto the water surface, the robot 100 may partially float on the water surface, and at this time, the attitude angle of the steering gear is locked to a certain value such that the blades 152 propel the robot 100 to glide on the water surface without rolling. Further, for the robot 100, the multirotor configuration is a state in which the sector-shaped panels 130 at each end overlap in pairs, the wheel configuration is a state in which the sector-shaped panels 130 at each end unfold in pairs, and the waterborne motion configuration is a state in which the adjacent sector-shaped panels 130 at each end unfold in pairs within the aforementioned preset angle range. After the robot 100 switches to the multirotor configuration, the motion control system controls the robot 100 to enter the flight mode. After the robot 100 enters the wheel configuration, the motion control system controls the robot 100 to enter the rolling mode. After the robot 100 enters the waterborne motion configuration, the motion control system controls the robot 100 to enter the waterborne motion mode.

Specifically, the motion control system is configured for controlling the robot 100 for flying, rolling, gliding on the water surface, or diving. The same motion control system may be used for the flight mode, the rolling mode, and the waterborne motion mode. The motion control system may be a flight control chip, which includes a plurality of sensors. The brand of the flight control chip can be selected according to actual needs, and there is no limitation here.

This embodiment provides a transformable multi-habitat robot 100 based on the principles of chiral origami, which can be driven by a folding/unfolding motor 170. The robot 100 can be folded or unfolded with a single degree of freedom based on an origami structural unit, and can completely switch between a multirotor configuration, a wheel configuration, and a waterborne motion configuration, and the three configurations do not interfere with each other. The motion control system controls the robot 100 to enter the flight mode in the multirotor configuration, enter the rolling mode in the wheel configuration, and enter the waterborne motion mode in the waterborne motion configuration, and the three motion modes operate in the respective configurations without interfering with each other. This embodiment can solve the technical problem in the related art that the overall volume of the robot 100 is increased by simple superposition of rotor and wheel structures, limiting certain functions and preventing the full realization of the advantages of both configurations. Meanwhile, it also solves the technical problems of increased complexity in control algorithms and implementation difficulties caused by increasing the degrees of freedom or adding rotor control. In addition, this embodiment can also realize the motion of the robot 100 on the water surface, so that the robot 100 can be applied to more scenarios.

In some embodiments, referring to FIG. 4, the overall structure of the robot 100 may include two central panels 111, with each end of the robot 100 including four sector-shaped panels 130. The four sector-shaped panels 130 at each end ensure that the robot 100 folds to form an X-shaped quadrotor configuration, and the robot 100 can perform stable flight motion in the X-shaped quadrotor configuration. Further, in this embodiment, comprehensive control of the flight attitude can be realized by simply adjusting the rotation speed of the four rotors, making the operation simple, and reducing the costs of manufacturing materials of the robot 100. In addition, when the robot 100 is switched to the wheel configuration, the four sector-shaped panels 130 at each end are unfolded in pairs to form a standard quadrangular pyramid structure, similar to a pyramid structure, which provides a structural foundation for the subsequent rolling of the robot 100. As in the aforementioned waterborne motion configuration, the robot 100 may perform waterborne motion in the wheel configuration, or may switch to any angle within the preset angle range, for example, 45 degrees or 90 degrees, to perform waterborne motion.

Specifically, the linkage component 110 includes two connecting rods 112 that overlap each other, an end of one connecting rod 112 is connected to a sector-shaped panel 130 at one end of the robot 100, and the other connecting rod 112 is connected to a sector-shaped panel 130 at the other end of the robot 100 at an opposite position. The robot 100 in FIG. 4 includes two central panels 111, and the two central panels 111 overlap each other. One central panel 111 is configured for connecting the sector-shaped panel 130 at the same end that is located at the opposite position of the sector-shaped panel 130 to which the connecting rod 112 is connected; the other central panel 111 is configured for connecting the sector-shaped panel 130 at the other end that is located at the opposite position of the sector-shaped panel 130 to which the connecting rod 112 is connected. That is, in the X-shaped quadrotor state, two sector-shaped panels 130 on the same straight line of the X-shape are respectively connected to the connecting rods 112, and the other two sector-shaped panels 130 on the other straight line of the X-shape are respectively connected to two central panels, and the two central panels overlap each other at the center of the entire linkage component 110, that is, the center of the X-shape.

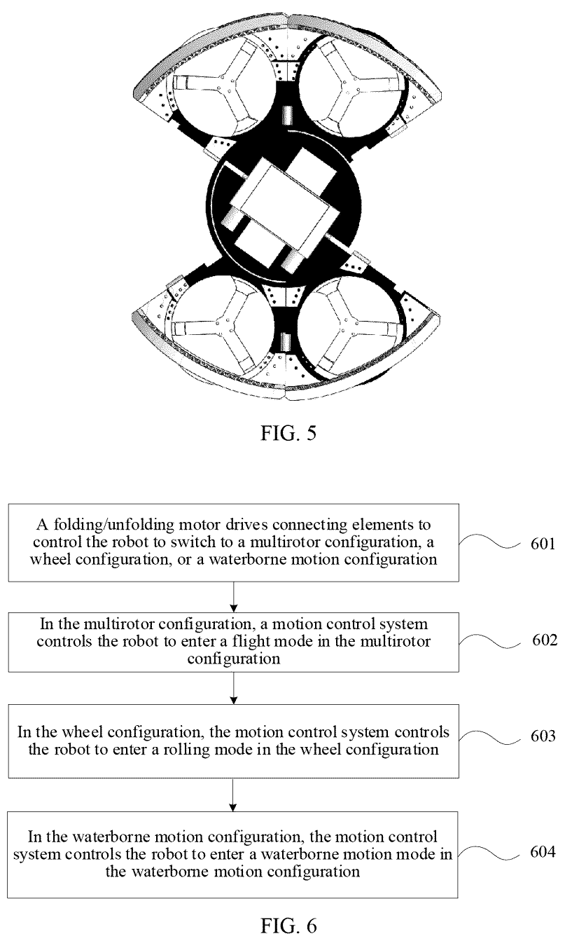

Further, every two adjacent sector-shaped panels 130 at each end are connected by a hinge or pivot, and four hinges or pivots are provided at each end of the robot 100. The folding/unfolding motor 170 is connected to the hinges or pivots through rotating shafts 190, with each end connected to a hinge or pivot. Under the drive of the folding/unfolding motor 170, the hinges or the pivots drive the sector-shaped panels 130 to fold or unfold. Further, referring to FIG. 5, FIG. 5 is a schematic diagram of a multirotor configuration of the robot 100 according to an embodiment of the present disclosure (buoyancy assemblies 1321 are not shown in the figure). Specifically, in the multirotor configuration, the sector-shaped panels 130 at each end overlap in pairs to form an X-shaped quadrotor. The two central panels 111 overlap each other and are on the same horizontal plane as the sector-shaped panels 130 paired at both ends. Still referring to FIG. 4, a wheel configuration of the robot 100 is also shown in FIG. 4, in which the four sector-shaped panels 130 at each end are unfolded in pairs to present a pyramid structure. When the robot 100 is switched to the corresponding configuration, the motion mode of the robot 100 is controlled by the motion control system. In the multirotor configuration, the motion control system controls the robot 100 to fly smoothly and perform tasks such as aerial surveys. The robot 100 has a simple and compact structure design, high flexibility, and can go deep into some narrow spaces for survey. In the wheel configuration, the robot 100 can move smoothly at a high speed, and adapt to some inspection tasks on land. In the waterborne motion configuration, the robot 100 can glide on the water surface or dive into the water, and perform some tasks such as water environment monitoring, water topography survey, and water quality detection. Therefore, the robot 100 according to the embodiments of the present disclosure can give full play to the advantages of a rotorcraft robot, a wheeled robot, and an aquatic robot, and has a broader range of application scenarios.

In some embodiments, the robot 100 according to the present disclosure utilizes rotor components 150 to supply power for flight, rolling, and waterborne motion for the entire robot 100. When the robot 100 is flying, the rotation of the blades 152 of the rotor components 150 can provide lift and propulsion to the robot 100, and the flight attitude of the robot 100 can be controlled by the tilt and rotation of the blades 152. When the robot 100 rolls, the rotor components 150 can provide thrust to the robot 100 to realize two-wheel rolling. When the robot 100 performs waterborne motion, the rotor components 150 can provide thrust to the robot 100 to realize rolling or gliding on the water surface, or even diving into the water. It can be understood that each sector-shaped panel 130 is provided with a through-hole 160, and the shape of the through-hole 160 can be selected according to actual situations. Referring to FIG. 4, a circular through-hole 160 is a preferred choice, as the circular through-hole 160 can ensure that the rotor components 150 experience uniform force in all directions, reducing vibration caused by eccentricity or imbalance, which is crucial for maintaining the stability of robot 100 during flight. The radius of the through-hole 160 needs to be adjusted according to the radius of the blades 152. In order to provide sufficient power for the robot 100 to move, a rotor component 150 needs to be mounted in the through-hole 160 of at least one sector-shaped panel 130 at each end, and the number of mounted rotor components 150 can be selected according to the actual weight of the robot 100 and the required power. The rotor component 150 includes a rotor motor 151 and blades 152, and also includes a rotor base and a rotor top, a threaded rotation shaft (not shown in the figure) for fixing and rotating the blades 152. When the robot 100 is in the flight mode, the rotor motor 151 can drive the blades 152 to rotate to provide power for the flight of the robot 100; and when the robot 100 is in the waterborne motion mode, the rotor motor 151 can drive the blades 152 to rotate, providing thrust for the robot 100 to move in the water. In some embodiments, referring to FIG. 4, if each end of the robot 100 has four sector-shaped panels 130, each end is provided with four through-holes 160 in total, and two through-holes 160 at each end are each provided with a rotor component 150.

In the embodiment of the present disclosure, by providing a through-hole 160 in the sector-shaped panel 130, and mounting a rotor component 150 in the through-hole 160, power is provided for flight, rolling or waterborne motion of the robot 100, and the stability of the robot 100 during movement is ensured.

In some embodiments, the mounting positions of the rotor components 150 need to be adjusted according to the number of rotor components 150 and the number of sector-shaped panels 130. Specifically, if the number of sector-shaped panels 130 at each end is four, and one rotor component 150 is mounted at each end, the rotor component 150 may be mounted in any one of the through-holes 160. When the robot 100 is in the multirotor configuration, the sector-shaped panels 130 overlap in pairs, and the rotor components 150 can be embedded in the through-holes 160 at opposite positions when folded, so that the two sector-shaped panels 130 reserve a placement space for the rotor components 150 when fitting together. In order to ensure the stability of the movement process of the robot 100, it is necessary to mount the rotor component 150 in the through-hole 160 at the opposite position of the other end. Further, it is also possible to mount two rotor components 150 at each end, as shown FIG. 4. In this case, it is necessary to mount the rotor components 150 in two non-adjacent through-holes 160 to ensure that sufficient space is reserved for placing the two rotor components 150 when the robot 100 is completely folded. Similarly, in order to ensure that both ends of the robot 100 can provide equal power when the robot 100 is moving and ensure the stability of movement of the robot 100, it is necessary to mount two rotor components 150 in the through-holes 160 at the opposite positions of the other end.

Further, if the number of sector-shaped panels 130 is six or eight or more, it is necessary to mount the rotor component 150 in one of the through-holes 160 of every two adjacent sector-shaped panels 130. Specifically, if there are six sector-shaped panels 130 at each end, and two rotor components 150 are mounted at each end, through-holes 160 need to be reserved for the two rotor components 150 only. If three rotor components 150 need to be mounted at each end, the rotor components 150 need to be mounted in one of the through-holes 160 in every two adjacent sector-shaped panels 130 to ensure that a placement space is reserved for each rotor component 150 when the robot 100 is folded into the multirotor configuration. At the same time, three rotor components 150 need to be mounted in the same manner at the other end.

In the embodiment of the present disclosure, by mounting the rotor components 150 in one through-hole 160 of every two adjacent sector-shaped panels 130, it is possible to reserve a fitting space for each rotor component 150 when the robot 100 is in the multirotor configuration, so that the sector-shaped panels 130 can overlap in pairs and fit together completely. Furthermore, mounting an equal number of rotor components 150 in the through-holes 160 at each end can provide equal power to both ends of the robot 100, and ensure the stability of the robot 100 when rolling, flying, gliding on the water surface, and diving.

In some embodiments, a support structure needs to be provided for the robot 100. In order to conform to the shape of the sector-shaped panel 130, referring to FIG. 4, an arc-shaped support component 132 is provided. The arc-shaped support component 132 is mounted on the side of the sector-shaped panel 130 away from the center panel 111, that is, at the end opposite the circular shape of the sector-shaped panel 130, and each sector-shaped panel 130 is mounted with an arc-shaped support component 132. Herein, the arc-shaped support component 132 may include a buoyancy assembly 1321, and the buoyancy assembly 1321 may be made of an elastic material such as Thermoplastic Polyurethane (TPU) or carbon fiber, in which a soft tire may be filled to provide buoyancy for the robot 100 during waterborne motion, or may be made of other materials, which may be selected according to actual needs, and there is no limitation here. In this embodiment, by providing the arc-shaped support components 132, it is possible to adapt to the structure of the sector-shaped panel 130. During landing of the robot 100, the support components 132 can act as a landing buffer to reduce the impact force when the robot 100 lands, thereby reducing the degree of damage to the internal devices of the robot 100, and also ensuring the stability of the attitude of the robot 100 when landing. When the robot 100 is in a wheel configuration, the arc-shaped support components 132 can function as a wheel to assist the robot 100 in rolling. When the robot 100 is in the waterborne motion configuration, the arc-shaped support components 132 can function as a wheel to help the robot 100 roll on the water surface or glide on the water surface while maintaining the wheel configuration.

In the aforementioned structure, every two adjacent sector-shaped panels 130 of the robot 100 is connected by a connecting element 140. Taking a hinge as an example, two leaf plates of the hinge are respectively connected to the two connected sector-shaped panels 130, and the connection manner is not limited here, and the two leaf plates are connected by the rotating shaft 190. The hinge is opened and closed around a pivot rotation axis under the drive of the folding/unfolding motor 170 to drive the sector-shaped panels 130 to fold or unfold, and realize complete switching between the multirotor configuration, the wheel configuration, and the waterborne motion configuration of the robot 100. Further, a slot 131 needs to be provided in a mirrored configuration for each connecting element 140 at the panel boundaries where the two adjacent sector-shaped panels 130 come into contact with each other. Refer to FIG. 4, which shows the position where the slot 131 is provided. The size of the slot 131 needs to match the size of the hinge that is in a mirrored configuration. In the embodiment of the present disclosure, the slots 131 are provided in the above-described manner, and space for placing hinges is reserved for the robot 100 in the multirotor configuration, so that the sector-shaped panels 130 overlapping in pairs can fit together completely.

Further, the control assembly of the robot 100 according to the embodiment of the present disclosure may further include an electronic speed controller, a power supply 180, and multiple sensors and actuators. Different sensors are provided, for example, the sensors can help the robot 100 acquire external environment information, construct a cognitive model of the environment, and collect relevant information for the control system of the robot 100 to realize control of the robot 100. In addition, the internal sensors of the robot 100 can monitor its own state, such as joint position, velocity, current, voltage, etc., to ensure that the robot 100 operates within a safe and expected parameter range. By providing different actuators, the robot 100 can perform different actions, such as grasping and releasing. Those of ordinary skills in the art can install these components on the central panels 111 according to actual needs, with no restrictions here.

The robot 100 designed based on the principles of chiral origami according to the embodiment of the present disclosure can drive the connecting elements 140 by the folding/unfolding motor 170 to drive the corresponding sector-shaped panels 130 to fold or unfold, and the sector-shaped panels 130 at each end of the robot 100 overlap in pairs or unfolded in pairs to realize the switching between the multirotor configuration, the wheel configuration and the waterborne motion configuration with a single degree of freedom. The robot 100 can enter the flight mode in the multirotor configuration, enter the rolling mode in the wheel configuration, and enter the waterborne motion mode in the waterborne motion configuration, thus realizing complete switching of the three configurations, and the three motion modes do not interfere with each other, giving full play to the advantages of the rotorcraft robot, the wheel robot, and the aquatic robot, and can adapt to more application scenarios.

For the above-described robot 100 designed based on origami principles, embodiments of the present disclosure further provide a motion control method of the robot 100, which is described in detail below.

Referring to FIG. 6, in some embodiments, the motion control method of the robot 100 includes, but is not limited to, the following steps 601 to 603.

At step 601, a folding/unfolding motor drives connecting elements to control the robot to switch to any one of a multirotor configuration, a wheel configuration, or a waterborne motion configuration.

At step 602, in the multirotor configuration, a motion control system controls the robot to enter a flight mode in the multirotor configuration.

At step 603, in the wheel configuration, the motion control system controls the robot to enter a rolling mode in the wheel configuration.

At step 604, in the waterborne motion configuration, the motion control system controls the robot to enter a waterborne motion mode in the waterborne motion configuration.

Specifically, in order to control the configuration of the robot 100, an embodiment of the present disclosure constructs dynamics equations of the robot 100, including dynamics equations for both the wheel configuration and the multirotor configuration. The dynamics equations describe the relationship between joint forces, torques, and the motion states (position, velocity, acceleration) of the robot 100, as well as the system response to external forces.

In some embodiments, the flight control dynamics equations of the robot 100 are as follows:

$$[ \begin{matrix}\ddot{x} \\ \ddot{y} \\ \ddot{z} \\ \ddot{φ} \\ \ddot{θ} \\ \ddot{ψ}\end{matrix} ] = [ \begin{matrix}\frac{K}{m} ( {ω}_{1}^{2} + {ω}_{2}^{2} + {ω}_{3}^{2} + {ω}_{4}^{2} ) ( cos ψ sin θ cos ϕ + sin ψ sin ϕ ) \\ \frac{K}{m} ( {ω}_{1}^{2} + {ω}_{2}^{2} + {ω}_{3}^{2} + {ω}_{4}^{2} ) ( sin ψ sin θ cos ϕ + cos ψ sin ϕ ) \\ \frac{K}{m} ( {ω}_{1}^{2} + {ω}_{2}^{2} + {ω}_{3}^{2} + {ω}_{4}^{2} ) cos θ cos ϕ - g \\ \frac{{I}_{x} - {I}_{y}}{{I}_{x}} \dot{θ} \dot{ψ} + \frac{kl cos \frac{α}{2}}{{I}_{x}} ( - {ω}_{1}^{2} - {ω}_{2}^{2} + {ω}_{3}^{2} + {ω}_{4}^{2} ) \\ \frac{{I}_{y} - {I}_{x}}{{I}_{x}} \dot{ϕ} \dot{ψ} + \frac{kl cos \frac{α}{2}}{{I}_{x}} ( - {ω}_{1}^{2} + {ω}_{2}^{2} + {ω}_{3}^{2} - {ω}_{4}^{2} ) \\ \frac{Kd}{{I}_{z}} ( {ω}_{1}^{2} - {ω}_{2}^{2} + {ω}_{3}^{2} - {ω}_{4}^{2} )\end{matrix} ]$$

Specifically, taking the robot 100 in FIG. 4 as an example, the flight control dynamics equations according to the embodiment of the present disclosure are presented. Herein, ω₁ represents the angular velocity of a first rotor motor 151, ω₂ represents the angular velocity of a second rotor motor 151, ω₃ represents the angular velocity of a third rotor motor 151, and ω₄ represents the angular velocity of a fourth rotor motor 151. K represents a lift coefficient of the rotor motor 151, and Kd represents a torque coefficient of the rotor motor 151. \ddot{x} represents the acceleration of the robot 100 in the x direction of the ground coordinate system, ÿ represents the acceleration of the robot 100 in the y direction of the ground coordinate system, \ddot{z} represents the acceleration of the robot 100 in the z direction of the ground coordinate system, and x, y, and z represent three coordinate axes in the Cartesian coordinate system, used to describe the position of the robot 100 in three-dimensional space. ϕ represents the yaw angle in the ground coordinate system, θ represents the pitch angle in the ground coordinate system, ψ represents the roll angle in the ground coordinate system, and g represents the acceleration of gravity. Iₓ, I_{y} and I_{z} represent the moments of inertia of the body of the robot around the x, y, and z axes of the body coordinate system, respectively. The flight control dynamics equations according to the embodiment of the present disclosure describe the acceleration of the robot 100 in each direction in the ground coordinate system and the relationship between the attitude angle and the force, torque, and the angular velocity of the rotor motor 151, and establish a flight control dynamics model of the robot 100. The equations reveal how state parameters such as flight attitude (such as yaw, pitch, and roll), position, velocity, and acceleration are affected by external forces (such as gravity, lift, and drag) and moments (generated by aerodynamic forces, engine thrust, gravity, etc.), thereby realizing the control of the flight mode of the robot 100.

In some embodiments, the rolling control dynamics equations of the robot 100 are as follows:

$$[ \begin{matrix}\dot{p} \\ \dot{q} \\ \dot{r}\end{matrix} ] = [ \begin{matrix}\begin{matrix}- \frac{K {sin}^{3} ( \frac{γ}{2} ) + 2 sin ( \frac{γ}{2} ) {cos}^{2} ( \frac{γ}{2} )}{2 {I}_{x} cos ( \frac{γ}{4} ) \sqrt{1 - {cos}^{4} ( \frac{γ}{2} )}} ( {ω}_{1}^{2} + {ω}_{2}^{2} - {ω}_{3}^{2} - {ω}_{4}^{2} ) + \\ Kd \frac{sin ( \frac{γ}{2} ) cos ( \frac{γ}{2} )}{{I}_{x} \sqrt{1 - {cos}^{4} ( \frac{γ}{2} )}} ( {ω}_{1}^{2} - {ω}_{2}^{2} + {ω}_{3}^{2} - {ω}_{4}^{2} )\end{matrix} \\ K d \frac{{sin}^{2} ( \frac{γ}{2} )}{{I}_{y} \sqrt{1 - {cos}^{4} ( \frac{γ}{2} )}} ( {ω}_{1}^{2} - {ω}_{2}^{2} + {ω}_{3}^{2} - {ω}_{4}^{2} ) \\ \begin{matrix}\frac{K {sin}^{3} ( \frac{γ}{2} ) + 2 sin ( \frac{γ}{2} ) {cos}^{2} ( \frac{γ}{2} )}{2 {I}_{z} cos ( \frac{γ}{4} ) \sqrt{1 - {cos}^{4} ( \frac{γ}{2} )}} ( {ω}_{1}^{2} + {ω}_{2}^{2} - {ω}_{3}^{2} - {ω}_{4}^{2} ) + \\ Kd \frac{sin ( \frac{γ}{2} ) cos ( \frac{γ}{2} )}{{I}_{z} \sqrt{1 - {cos}^{4} ( \frac{γ}{2} )}} ( {ω}_{1}^{2} - {ω}_{2}^{2} + {ω}_{3}^{2} - {ω}_{4}^{2} )\end{matrix}\end{matrix} ]$$

Specifically, p, q, and r represent the angular velocity components of the robot 100 around three orthogonal axes of its local coordinate system (that is, the body coordinate system), where p corresponds to the angular velocity component of the robot 100 in the x-axis direction of the body coordinate system of the robot 100, q corresponds to the angular velocity component of the robot 100 in the y-axis direction of the body coordinate system of the robot 100, and r represents the angular velocity component of the robot 100 in the z-axis direction of the body coordinate system of the robot 100.

Further, ω₁ represents the angular velocity of a first rotor motor 151, ω₂ represents the angular velocity of a second rotor motor 151, ω₃ represents the angular velocity of a third rotor motor 151, and ω₄ represents the angular velocity of a fourth rotor motor 151. K represents a lift coefficient of the rotor motor 151, Kd represents a torque coefficient of the rotor motor 151, y represents the angle formed by the axes of two sets of opposite hinges, and Iₓ, I_{y} and I_{z} represent the moments of inertia of the body of the robot around the x, y, and z axes of the body coordinate system, respectively. The dynamics equations of rolling control according to the embodiment of the present disclosure are mainly used to describe and analyze the motion characteristics and control strategies of the robot 100 when performing an action in the wheel configuration, and reveals how factors such as force conditions, moment of inertia, and force of each part (including wheels, joints, body, etc.) of the robot 100 work together to affect the rolling behavior of the robot 100 during the rolling process. Since the robot 100 can glide on the water surface or dive into the water in the wheel configuration, the principle of the waterborne motion control dynamics equations of the robot 100 is similar to that of the rolling control dynamics equations, and will not be repeated herein.

In the embodiment of the present disclosure, a model of the robot 100 for flight control, rolling control, and waterborne motion control of the robot 100 is constructed, and the waterborne motion control of the robot 100 can also be realized by the aforementioned motion model. The corresponding control system is arranged on the robot 100 to control the flight, rolling, and folding of the robot 100, the hinges and folding/unfolding motor 170 are used to drive the origami slab structure of the robot 100, allowing complete switch between the multirotor configuration, the wheel configuration, and the waterborne motion configuration of the robot 100 through the folding and unfolding motion. The embodiment of the present disclosure can realize the switching and control of the robot 100 in the above three motion configurations by only one folding/unfolding motor 170.

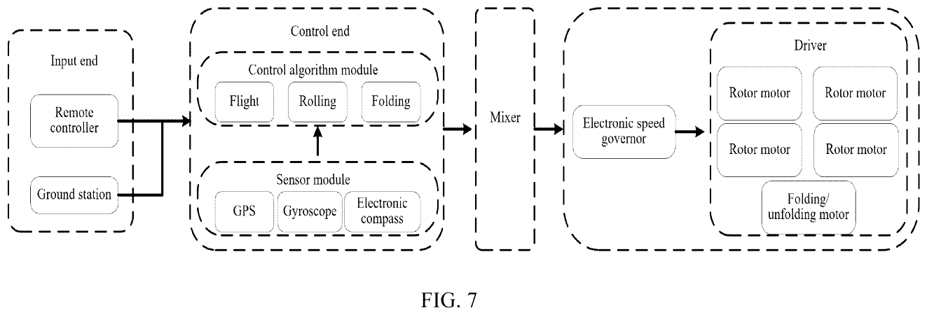

In some embodiments, after the robot 100 switches to the wheel configuration, the multirotor configuration, or the waterborne motion configuration, the motion control system controls the motion of the robot 100 in different configurations. Referring to FIG. 7, FIG. 7 is a schematic diagram of a motion control system of the robot 100 according to an embodiment of the present disclosure. The driver module of the motion control system in FIG. 7 includes four rotor motors 151, and the working principle of the motion control system is explained by taking the robot 100 shown in FIG. 4 as an example, and two rotor motors 151 are mounted at each end of the robot 100 in FIG. 4. The motion control system is arranged according to the analysis of the dynamics modeling equations. As shown in FIG. 7, the whole control system includes an input end, a control end and an execution end. The input end can receive remote controller control information from a remote controller and control information from a ground station. It utilizes various remote sensing instruments installed on a remote sensing platform to capture electromagnetic wave information from the environment, and transmits this information to the ground receiving station in real-time through a radio transmission system on the remote sensing platform. The ground station can receive remote controller control information and issue instructions to remotely control the robot 100.

Further, the control information from the remote controller and the control signals from the ground station are input to the control end for processing. The control end includes related control algorithm module for controlling the flight, rolling, folding and waterborne motion of the robot 100, and a sensor module. The sensor module includes a Global Positioning System (GPS), a gyroscope, and an electronic compass. The GPS is used to acquire geographical location information and provide three-dimensional coordinates (latitude, longitude, altitude) for accurate positioning. The gyroscope is used to measure the angular velocity of the robot 100, that is, the speed and direction of the rotation of the object in space, and is used to estimate the attitude and motion trajectory of the robot 100. The electronic compass is used to acquire directional information. The control algorithm module receives the control information from the remote controller and the control information from the ground station at the input end, as well as the GPS information, the gyroscope information and the electronic compass information collected by the sensor module, infers the state of the robot 100 according to various sensor information through the preset control strategies and control algorithms, and calculates and outputs pulse width modulated signals of the motors according to the state of the robot 100 and the control signal information. The pulse width modulated signals of the motors include pulse width modulated signals of the rotor motors 151 and the folding/unfolding motor 170.

In some embodiments, the core of the control end is the internal control algorithm module, and the control algorithms determine various motion strategies of the robot 100 in the multirotor configuration, the wheel configuration or the waterborne motion configuration. A mixer serves to convert the attitude control commands output by the attitude control algorithm into specific output control signals of the motors. The mixer maps the attitude control commands to motor rotational speeds suitable for the robot 100, thereby driving the robot 100 to move according to a desired attitude change.

The execution end consists of a driver and an electronic speed governor. The electronic speed governor adjusts the magnitude and frequency of the current or voltage supplied to the motors to achieve precise control of the motor speed. The driver includes the rotor motors 151 and the folding/unfolding motor 170. The pulse width modulated signal output by the mixer is input to the electronic speed governor at the execution end, and the corresponding motor speed is acquired to control the rotor motors 151 and the folding/unfolding motor 170. The motion control system according to the embodiment of the present disclosure can control the motion modes of the robot 100 in the multirotor configuration, the wheel configuration, and the waterborne motion configuration, and realizes the conversion of three motion modes of flight, rolling, and waterborne motion through the folding motion of the robot in a single degree of freedom, and the motion modes do not interfere with each other.

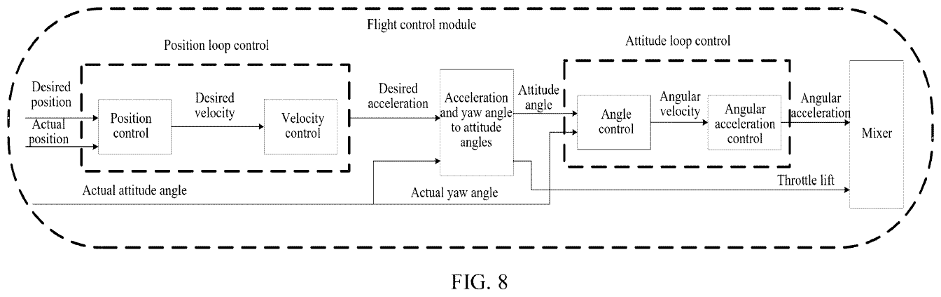

In some embodiments, the position control of the flight control module, the rolling control module, and the waterborne motion control module provided in the present disclosure adopts a Proportional-Integral-Derivative (PID) control algorithm to acquire the required acceleration of the robot 100 in the flight mode, the rolling mode, and the waterborne motion mode according to the input position information. Referring to FIG. 8, FIG. 8 is a structural diagram of a flight control module according to an embodiment of the present disclosure. The flight control module includes position loop control and attitude loop control, as well as a function that converts acceleration and yaw angle to attitude angle, and a mixer. The position loop control includes position control and velocity control. The attitude loop control includes angle control and angular acceleration control. The preset desired position and actual position information are input into the position loop control, and the desired velocity is calculated by the position control algorithm, and the desired acceleration is obtained from the desired velocity by the velocity control algorithm. The desired acceleration and the actual attitude angle are processed via the function that converts acceleration and yaw angle to attitude angle to obtain the attitude angle and throttle lift. The result of attitude angle, the actual yaw angle and the actual attitude angle are input to the attitude loop control algorithm, and the angular velocity is obtained by the angle control module, and the angular velocity is processed via the angular acceleration control algorithm and then the angular acceleration is output. The throttle lift and the angular acceleration are input to the execution end of the motion control system through the mixer.

The flight control module according to the embodiment of the present disclosure mainly includes position loop control and attitude loop control. These modules realize precise control of the position, flight velocity, angular velocity, and flight attitude of the robot 100 through a feedback control system.

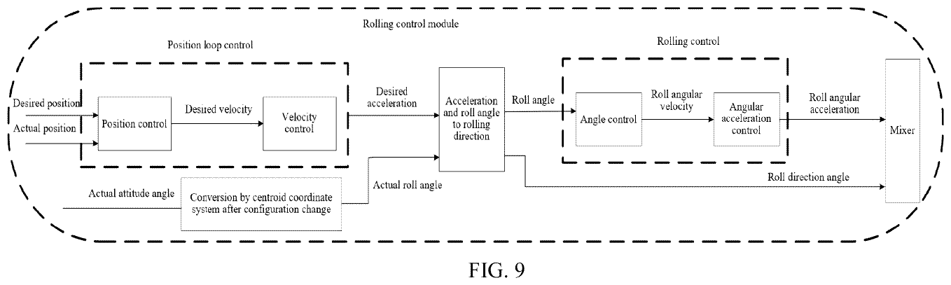

In some embodiments, referring to FIG. 9, FIG. 9 is a structural diagram of a rolling control module according to an embodiment of the present disclosure. The rolling control module includes a position loop control module, a rolling control module, a module that converts acceleration and roll angle to rolling direction, and a mixer. The preset desired position coordinates and the actual position information of the robot 100 are input to the position loop control module. In the position loop control module, the desired position and the actual position are processed by the position control algorithm to obtain the desired velocity, and the desired acceleration is calculated after the desired velocity is processed by the velocity control algorithm. On the other hand, the actual attitude angle is converted into the actual roll angle after being processed based on the centroid coordinate system after configuration change. The actual roll angle and the desired acceleration output by the position loop control module are input to the module that converts acceleration and roll angle to rolling direction, and then the roll angle and the rolling direction angle are output. The roll angle is input to the rolling control module, and processed by the angle control algorithm to obtain the roll angular velocity, and the roll angular velocity is processed by the acceleration control algorithm to obtain the roll angular acceleration, that is, the output of the rolling control module is the roll angular acceleration. Finally, the information of the rolling direction angle and the roll angular acceleration is input to the mixer to obtain the pulse width modulated signals of the motors, and the pulse width modulated signal is input to the execution end of the motion control system to control the rolling mode of the robot 100 in the wheel configuration.

The rolling control module according to the embodiment of the present disclosure mainly includes position loop control and rolling control. These modules realize precise control of the rolling direction, rolling velocity, and rolling attitude of the robot 100 through a feedback control system.

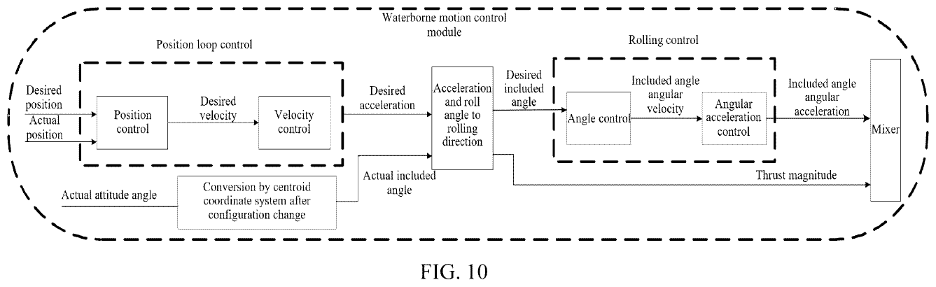

In some embodiments, referring to FIG. 10, FIG. 10 is a structural diagram of a waterborne motion control module according to an embodiment of the present disclosure. Specifically, the waterborne motion control module includes a position loop control module, a rolling control module, a module that converts acceleration and roll angle to rolling direction, and a mixer. The preset desired position coordinates and the actual position of the robot 100 are input to the position loop control module, and the desired velocity is calculated by the position control algorithm in the position loop control module, and the desired velocity is calculated by the velocity control module based on the velocity control algorithm to obtain the desired acceleration. On the other hand, the actual attitude angle of the robot 100 is converted into the actual included angle after being processed based on the centroid coordinate system after configuration change, where the included angle indicates the included angle between the body coordinate axis of the robot 100 and the horizontal plane. By adjusting the included angle within the above-described angle range, it is possible to provide thrust to the robot 100 and also prevent the robot 100 from overturning. The actual included angle and the desired acceleration output by the position loop control module are input to the module that converts acceleration and roll angle to rolling direction, and then the desired included angle and thrust magnitude are output. Further, the desired included angle is input to the rolling control module, and processed by the angle control algorithm to obtain the included angle angular velocity, and the included angle angular velocity is processed by the angular acceleration control algorithm to obtain the included angle angular acceleration, that is, the output of the rolling control module is the included angle angular acceleration. Finally, the thrust magnitude and the included angle angular acceleration are input to the mixer to obtain the pulse width modulated signals of the motors, and the pulse width modulated signals are input to the execution end of the motion control system to control the waterborne motion mode in the waterborne motion configuration of the robot 100.

The waterborne motion control module according to the embodiment of the present disclosure mainly includes the position loop control module and the rolling control module. These modules realize the precise control of the waterborne motion direction, waterborne motion velocity and waterborne motion attitude of the robot 100 through a feedback control system.

Through the flight control module, the rolling control module, and the waterborne motion control module provided in the foregoing steps, any one of the calculated flight motion control information, the rolling control information, or the waterborne motion control information is input to the execution end to control the robot 100 to fold and unfold through the rotor motors 151 and the folding/unfolding motor 170, enabling the three motion configurations, i.e., the flight configuration, the wheel configuration, and the waterborne motion configuration, to be independent of each other, and the three motion modes of flight, rolling, or waterborne motion are switched under the corresponding motion configurations, so that the robot 100 can adapt to more application scenarios.

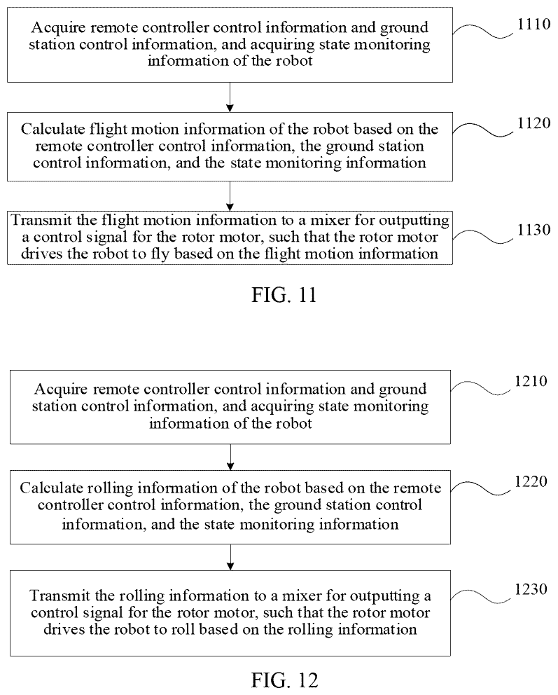

In some embodiments, referring to FIG. 11, which is a flowchart of step 602 in FIG. 6 according to an embodiment of the present disclosure, step 602 includes but is not limited to the following steps.

At step 1110, remote controller control information and ground station control information are acquired, and state monitoring information of the robot is acquired.

At step 1120, flight motion information of the robot is calculated based on the remote controller control information, the ground station control information, and the state monitoring information.

At step 1130, the flight motion information is transmitted to a mixer for outputting a control signal for the rotor motor, such that the rotor motor drives the robot to fly based on the flight motion information.

Specifically, the remote controller control information is control information generated by the remote controller, and the remote controller control information may include control instructions sent to a sensor or an actuator mounted on the remote sensing platform. The ground station control information may include information such as flight or rolling plan, current position, flight altitude, velocity, heading, track, flight status (such as ascent, descent, cruise) and preset motion route, and the ground station control information may also include mission planning information such as flight path planning, observation area setting, time series, etc., which are used to guide the remote sensing platform on how to perform predetermined remote sensing tasks. The information helps the ground station monitor and guide the motion status of the robot in real time. The state monitoring information is acquired through the sensor, and the state monitoring information may include whether the device is working normally, battery power, sensor status, storage capacity, and the like.

Further, the flight module in the control end of the motion control system processes the acquired data, and outputs the flight actuation information from the mixer to the execution end of the motion control system. The flight actuation information may include drive instructions or motor control signals of the rotor motors, which may typically include a desired rotation speed, torque, or pulse width modulated (PWM) signal of the motor in order to control the motor to output an appropriate thrust or torque to achieve a desired flight motion mode. After the flight motion information is input to the mixer, it will be further processed and distributed by the mixer, so as to interface with the specific actuators and drivers of the execution end to realize the flight of the robot.

In some embodiments, referring to FIG. 12, which is a flowchart of step 603 in FIG. 6 according to an embodiment of the present disclosure, step 603 includes but is not limited to the following steps.

At step 1210, remote controller control information and ground station control information are acquired, and state monitoring information of the robot is acquired.

At step 1220, rolling information of the robot is calculated based on the remote controller control information, the ground station control information, and the state monitoring information.

At step 1230, the rolling information is transmitted to a mixer for outputting a control signal for the rotor motor, such that the rotor motor drives the robot to roll based on the rolling information.

Specifically, the remote controller control information and the ground station control information have been described in the foregoing steps, and will not be repeated here. After acquiring the remote controller control information and the ground station control information, the rolling module in the control algorithm module processes the data, and outputs the processed data through the mixer to obtain the rolling actuation information. Since both the rolling and flight of the robot are realized by providing lift or thrust by the rotor motors, the rolling actuation information output by the control end of the motion control system also corresponds to the driving instructions or control signals of the rotor motors. After receiving the rolling actuation information output by the control end, the execution end activates the corresponding actuator and driver to perform the rolling motion.

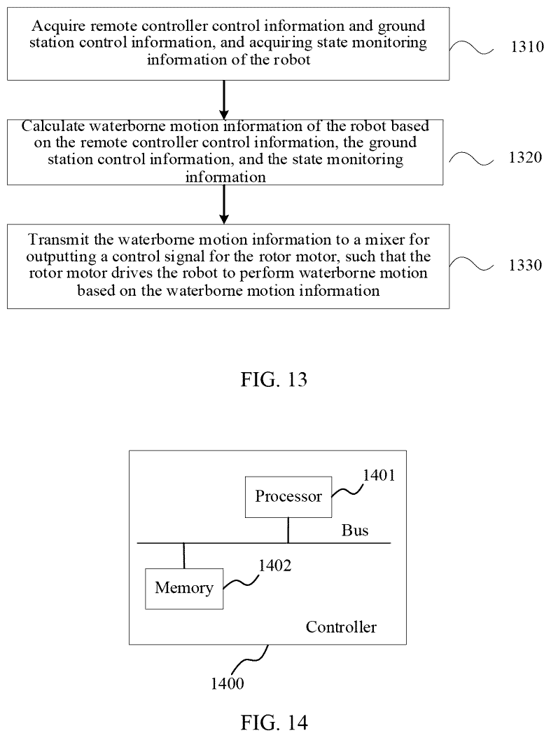

In some embodiments, referring to FIG. 13, which is a flowchart of step 604 in FIG. 6 according to an embodiment of the present disclosure, step 604 includes but is not limited to the following steps.

At step 1310, remote controller control information and ground station control information are acquired, and state monitoring information of the robot is acquired.

At step 1320, waterborne motion information of the robot is calculated based on the remote controller control information, the ground station control information, and the state monitoring information.

At step 1330, the waterborne motion information is transmitted to a mixer for outputting a control signal for the rotor motor, such that the rotor motor drives the robot to perform waterborne motion based on the waterborne motion information.

Specifically, the remote controller control information and the ground station control information have been described in the foregoing steps, and will not be repeated here. After acquiring the remote controller control information and the ground station control information, the information can be processed by a rolling module in the control algorithm module. Since the motion modes of the waterborne motion and the rolling motion are similar, the rolling module can process the aforementioned information. Alternatively, the remote controller control information and the ground station control information may also be processed by a separate waterborne motion module (not shown in the figure), and then the processed data may be output through the mixer to acquire waterborne actuation information. Since the waterborne motion of the robot can be realized in the wheel configuration, the rotor motors can provide thrust to the robot 100 to realize the waterborne motion, and thus the waterborne actuation information output through the control end of the motion control system also corresponds to the driving instructions or control signals of the rotor motors. After receiving the waterborne actuation information output by the control end, the execution end activates the corresponding actuator and driver to perform the rolling motion.

The present disclosure may be used in a wide variety of general purpose or special purpose computer system environments or configurations, for example: personal computers, server computers, handheld devices or portable devices, tablet devices, multiprocessor systems, microprocessor-based systems, set-top boxes, programmable consumer electronics, network PCs, mini-computers, mainframe computers, and any distributed computing environments that include the aforementioned systems or devices, among others. The present disclosure may be described in the general context of computer-executable instructions executed by a computer, such as program modules. Typically, program modules include routines, programs, objects, components, data structures, and the like that perform specific tasks or implement specific abstract data types. The present disclosure may also be practiced in distributed computing environments in which tasks are performed by remote processing devices connected through a communication network. In a distributed computing environment, program modules may be located in local and remote computer storage media, including storage devices.

An embodiment of the present disclosure provides a controller. Referring to FIG. 14, FIG. 14 is a schematic diagram of a controller for executing a motion control method of a robot according to an embodiment of the present disclosure. The controller comprises: a processor, a memory, and a computer program stored in the memory and executable by the processor.

A controller 1400 according to an embodiment of the present disclosure includes at least one processor 1401 and at least one memory 1402. In FIG. 14, one processor 1401 and one memory 1402 are shown as an example.

The processor 1401 and the memory 1402 may be connected by a bus or in other ways. In FIG. 14, the connection is realized by a bus for example.

As a non-transitory computer-readable storage medium, the memory 1402 may be configured to store a non-transitory software program and a non-transitory computer-executable program. In addition, the memory 1402 may include a high-speed random access memory and a non-transitory memory, for example, at least one magnetic disk storage device, a flash memory device, or another non-transitory solid-state storage device.

It can be understood by those of ordinary skill in the art that the device structure shown in FIG. 14 does not constitute a limitation to the controller 1300, and more or fewer components, or a combination of certain components, or a different component arrangement is possible.

In the controller 1400 illustrated in FIG. 14, the processor 1401 may be configured to implement the motion control method of the robot by calling a motion control program of the robot stored in the memory 1402.

A further embodiment of the present disclosure provides a computer-readable storage medium storing a computer program which, when executed by a processor, causes the processor to perform the motion control method of the robot described above.

As a non-transitory computer-readable storage medium, the memory can be configured to store a non-transitory software program and a non-transitory computer-executable program. In addition, the memory may include a high-speed random access memory and a non-transitory memory, for example, at least one magnetic disk storage device, a flash memory device, or another non-transitory solid-state storage device. In some implementations, the memory may optionally include memories remotely located with respect to the processor, and these remote memories may be connected to the processor via a network. Examples of the above-mentioned network include, but are not limited to, the Internet, an intranet, a local area network, a mobile communication network, and a combination thereof.

It should be noted that the controller in this embodiment may include the processor and the memory as in the embodiment shown in FIG. 14. They belong to the same inventive concept, so both of them have the same implementation principle and beneficial effects, which will not be repeated here.

To implement the motion control method of the robot based on origami principles in the above-described embodiments, the required non-transitory software program and instructions are stored in a memory, and when executed by a processor, cause the processor to execute the motion control method of the robot based on origami principles in the above-described embodiments.

A further embodiment of the present disclosure provides a computer-readable storage medium storing computer-executable instructions for executing the above-described motion control method of the robot based on origami principles. The computer-executable instructions, when executed by one or more processors, for example, the processor 1401 in FIG. 14, may cause the one or more processors to execute the motion control method in the above-described method embodiments, for example, to execute the above-described method steps 601 to 604 in FIGS. 6, 1110 to 1130 in FIGS. 11, 1210 to 1230 in FIG. 12, and 1310 to 1330 in FIG. 13.

The apparatus embodiments described above are only for illustration. The units described as separate components may or may not be physically separated, that is, they may be located at one place or distributed to multiple network units. Some or all of the modules can be selected according to actual needs to achieve the objective of the embodiments of the present disclosure.

It can be understood by those of ordinary skill in the art that all or some of the steps in the methods, functional modules/units in the systems and devices disclosed above can be implemented as software, firmware, hardware and appropriate combinations thereof.

The terms “first”, “second”, “third”, “fourth”, etc. (if any) in the specification and the above-mentioned drawings of the present disclosure are intended to distinguish similar objects and are not necessarily to describe a specific order or sequence. It should be understood that the ordinal numerals used in such a way can be interchanged where appropriate so that the embodiments of the present disclosure described herein can be implemented in an order other than those illustrated or described herein. Further, the terms “include” and “have” and any variations thereof are intended to encompass non-exclusive inclusion. For example, a process, method, system, product, or device that includes a series of steps or components is not limited to those steps or components explicitly listed, but may include additional steps or components that are not explicitly listed or that are inherent to such processes, methods, products, or devices.

It should be understood that, in the present disclosure, “at least one” means one or more, and “a plurality of” means two or more. The term “and/or” is used to describe an association relationship between associated objects, and indicates that three relationships may exist, for example, A and/or B may indicate that: only A exists, only B exists, and both A and B exist, where A or B may be singular or plural. The character “/” generally indicates an “or” relationship between associated objects before and after the character. “At least one of” or similar expressions refers to any combination of these items, including any combination of single items or plural items. For example, at least one of a, b, or c may indicate: a, b, and c, “a and b”, “a and c”, “b and c”, or “a and b and c”, where a, b, or c may be singular or plural.

In the embodiments provided by the present disclosure, it should be understood that the disclosed device and method can be realized in alternative ways. For example, the device embodiments described above are only for illustration. For example, the division of the units is only a logic function division. In actual implementation, there may be alternative manners for the division, for example, multiple units or components may be combined or integrated into another system, or some features may be omitted or not implemented. Further, the mutual coupling or direct coupling or communication connection shown or discussed may be indirect coupling or communication connection through some interfaces, devices or units, and may be in electrical, mechanical or other forms.

The above units described as separate components may or may not be physically separated, and the components displayed as units may or may not be physical units, that is, they may be located in one place or distributed to multiple network units. Some or all of the units can be selected according to actual needs to achieve the objective of the embodiments of the present disclosure.

In addition, the functional units in each embodiment of the present disclosure may be integrated into one processing unit, or each unit may be physically separate, or two or more units may be integrated into one unit. The integration unit can be realized either in the form of hardware or in the form of a software functional unit.

If the integrated units are implemented in the form of functional units of software and sold or used as independent products, they can be stored in a computer-readable storage medium. On the basis of such understanding, the substance or the parts that contribute to the existing technology or all or a part of the technical schemes of the present disclosure may be embodied in the form of a software product, which is stored in a storage medium and includes a number of instructions to cause a computer device (which can be a personal computer, a server, or a network device, etc.) to execute all or some of the steps of the method described in the embodiments of the present disclosure. The aforementioned storage medium includes: various media that can store program codes, such as a USB flash drive, a mobile hard disk, a read-only memory (ROM), a random access memory (RAM), a magnetic disk or an optical disk.

Preferable embodiments of the present disclosure have been described above with reference to the accompanying drawings and are not to limit the scope of the present disclosure. Any modifications, equivalent substitutions, and improvements made by those of ordinary skill in the art without departing from the scope and essence of the present disclosure shall fall within the scope of the present disclosure.

What is claimed is:

1. A robot based on origami principles, comprising: linkage components, central panels, and a plurality of sector-shaped panels, wherein:
two ends of the linkage components are connected to a same number of the sector-shaped panels, with every two adjacent sector-shaped panels connected by a respective one of connecting elements;
the central panels are located in a middle of the linkage components, and the central panels are configured for placement of a control assembly, the control assembly comprising a folding/unfolding motor and a motion control system;
the folding/unfolding motor is configured to drive the connecting elements to control the robot to switch to any one of a multirotor configuration, a wheel configuration, or a waterborne motion configuration, wherein the multirotor configuration refers to a state in which the sector-shaped panels at each end overlap in pairs, the wheel configuration refers to a state in which the sector-shaped panels at each end unfold in pairs, and the waterborne motion configuration refers to a state in which the sector-shaped panels at each end unfold in pairs within a preset angle range; and
the motion control system is configured to control the robot to enter any one of a flight mode in the multirotor configuration, a rolling mode in the wheel configuration, or a waterborne motion mode in the waterborne motion configuration.

2. The robot of claim 1, wherein each of the sector-shaped panels is provided with a through-hole, a rotor component is mounted in the through-hole of at least one of the sector-shaped panels at each end, the rotor component comprises a rotor motor and blades, and the rotor motor is configured to drive the blades to rotate in any one of the flight mode, the rolling mode, or the waterborne motion mode.

3. The robot of claim 2, wherein the rotor component is mounted in the through-hole of one of every two adjacent sector-shaped panels.

4. The robot of claim 1, wherein a side of each of the sector-shaped panels that is away from the central panels is mounted with an arc-shaped support component, the arc-shaped support component comprising a buoyancy assembly.

5. The robot of claim 1, wherein a slot is provided in a mirrored configuration for each of the connecting elements in the two adjacent sector-shaped panels, and the slot is configured to, when in the state of overlapping in pairs, accommodate the respective connecting element that is in the mirrored configuration.

6. A motion control method, which is applied to a robot based on origami principles,
the robot comprising: linkage components, central panels, and a plurality of sector-shaped panels, wherein:
two ends of the linkage components are connected to a same number of the sector-shaped panels, with every two adjacent sector-shaped panels connected by a respective one of connecting elements;
the central panels are located in a middle of the linkage components, and the central panels are configured for placement of a control assembly, the control assembly comprising a folding/unfolding motor and a motion control system;
the folding/unfolding motor is configured to drive the connecting elements to control the robot to switch to any one of a multirotor configuration, a wheel configuration, or a waterborne motion configuration, wherein the multirotor configuration refers to a state in which the sector-shaped panels at each end overlap in pairs, the wheel configuration refers to a state in which the sector-shaped panels at each end unfold in pairs, and the waterborne motion configuration refers to a state in which the sector-shaped panels at each end unfold in pairs within a preset angle range; and
the motion control system is configured to control the robot to enter any one of a flight mode in the multirotor configuration, a rolling mode in the wheel configuration, or a waterborne motion mode in the waterborne motion configuration,
the motion control method comprising:
driving the connecting elements by the folding/unfolding motor to control the robot to switch to any one of a multirotor configuration, a wheel configuration, or a waterborne motion configuration, wherein the multirotor configuration refers to a state in which the sector-shaped panels at each end overlap in pairs, the wheel configuration refers to a state in which the sector-shaped panels at each end unfold in pairs, and the waterborne motion configuration refers to a state in which the sector-shaped panels at each end unfold in pairs within a preset angle range;
in the multirotor configuration, controlling, by the motion control system, the robot to enter a flight mode in the multirotor configuration;
in the wheel configuration, controlling, by the motion control system, the robot to enter a rolling mode in the wheel configuration; and
in the waterborne motion configuration, controlling, by the motion control system, the robot to enter a waterborne motion mode in the waterborne motion configuration.

7. The motion control method of claim 6, wherein the controlling, by the motion control system, the robot to enter a flight mode in the multirotor configuration comprises:
acquiring remote controller control information and ground station control information, and acquiring state monitoring information of the robot;
calculating flight motion information of the robot based on the remote controller control information, the ground station control information, and the state monitoring information; and
transmitting the flight motion information to a mixer for outputting a control signal for the rotor motor, such that the rotor motor drives the robot to fly based on the flight motion information.

8. The motion control method of claim 6, wherein the controlling, by the motion control system, the robot to enter a rolling mode in the wheel configuration comprises:
acquiring remote controller control information and ground station control information, and acquiring state monitoring information of the robot;
calculating rolling information of the robot based on the remote controller control information, the ground station control information, and the state monitoring information; and
transmitting the rolling information to a mixer for outputting a control signal for the rotor motor, such that the rotor motor drives the robot to roll based on the rolling information.

9. The motion control method of claim 6, wherein the controlling, by the motion control system, the robot to enter a waterborne motion mode in the waterborne motion configuration comprises:
acquiring remote controller control information and ground station control information, and acquiring state monitoring information of the robot;
calculating waterborne motion information of the robot based on the remote controller control information, the ground station control information, and the state monitoring information; and
transmitting the waterborne motion information to a mixer for outputting a control signal for the rotor motor, such that the rotor motor drives the robot to perform waterborne motion based on the waterborne motion information.

10. A controller, comprising a memory, a processor, and a computer program stored in the memory and executable on the processor, wherein the computer program, when executed by the processor, causes the processor to implement the motion control method of claim 6.

11. A non-transitory computer-readable storage medium storing a computer program, wherein the computer program, when executed by a processor, causes the processor to implement the motion control method of claim 6.
